(19) United States
(12) Patent Application Publication
(10) Pub. No.: US 2016/0025682 A1
(43) Pub. Date: Jan. 28, 2016

(54) FLEXIBLE EDDY CURRENT PROBE

(71) Applicant: Electric Power Research Institute Inc., Palo Alto, CA (US)

(72) Inventors: Stanley Maurice WALKER, Midland, NC (US); Gary Lane BURKHARDT, Adkins, TX (US); Matthew Louis CAPPS, San Antonio, TX (US); Jonathan Dale BARTLETT, San Antonio, TX (US)

(21) Appl. No.: 14/413,468

(22) PCT Filed: Aug. 30, 2012
(86) PCT No.: PCT/US2012/052982

§ 371 Date: Mar. 10, 2015

Related U.S. Application Data
(60) Provisional application No. 61/670,906, filed on Jul. 12, 2012.
(60) Provisional application No. 61/670,509, filed on Jul. 11, 2012.

(51) Int. Cl. G01N 27/90

(52) U.S. Cl. CPC G01N 27/9033; G01N 27/904

(57) ABSTRACT

A flexible eddy current probe and a method of use are provided. A flexible eddy current probe (300) includes at least one substantially planar eddy current array (304) capable of measuring an electromagnetic condition of a portion of a test object (202), wherein the at least one eddy current array (304) is disposed on a flexible substrate (316), and wherein the flexible substrate (316) is conformable to a portion of the test object (202). The flexible eddy current probe includes at least one elongated electrical conductor (312) capable of electrically connecting the at least one eddy current array (304) to a test instrument, and a glove (402) capable of being fitted to an operator's hand and capable of carrying the eddy current array (304) and conforming the array in testing communication with the test object (202).

Non-destructive testing generally comprises those test methods that may be used to examine an object, material or system without impairing its future usefulness. Non-destructive testing is concerned with aspects of the uniformity, quality and serviceability of materials and structures. Many non-destructive testing techniques, such as ultrasonic and eddy-current testing, are efficient since they may be utilized without removing a test object from surrounding structures. Non-destructive testing techniques are also effective for discovering hidden defects that are not otherwise identifiable through visual inspection.

Non-destructive testing is particularly useful in certain industries, e.g., aerospace and power generation, that require inspection of metal components for potential safety-related or quality-related problems. In the power generation industry, heat recovery steam generators are utilized to remove heat from exhaust gases, typically from a gas turbine, in order to convert the energy to steam. The steam may be used for industrial processes or to drive a turbine generator to produce electricity. Leaks caused by failures of boiler tubes, welds and other components in heat recovery steam generators present a problem.

The most common location for failures to occur in heat recovery steam generators is at the tube-to-header welds. The tube-to-header weld attachment is particularly troublesome due to thermal differences experienced between the header and the tubes during cyclic operation. Tubes attached to the header tend to cool very rapidly to the temperature of the incoming water while the bulk wall temperature of the header tends to respond much more slowly due to thickness variations. Thermal shock results and can lead to thermal fatigue failures at the tube weld. Thermal fatigue cracking of tube-to-header welds in heat recovery steam generators and conventional power plant boilers has been reported in the United States.

Tube-to-header weld defects are usually very difficult to access as they are often behind rows of tubes or other obstacles. Moreover, the geometry of the weld is complex and is characterized by weld beads located at the intersection of a large diameter cylindrical header and a small diameter cylindrical tube. Non-destructive testing, such as eddy current testing, may be utilized to inspect tube-to-header welds, however, obtaining accurate test results is not straightforward since the welds are intricate and difficult to access. What is needed are improved devices and methods for performing accurate and efficient non-destructive testing of difficult to access test objects, and objects having complex geometry, for example, the tube-to-header welds of a heat recovery steam generator.

For the purposes of this disclosure, the term “eddy current array” refers to multiple eddy current coils arranged in an organized pattern.

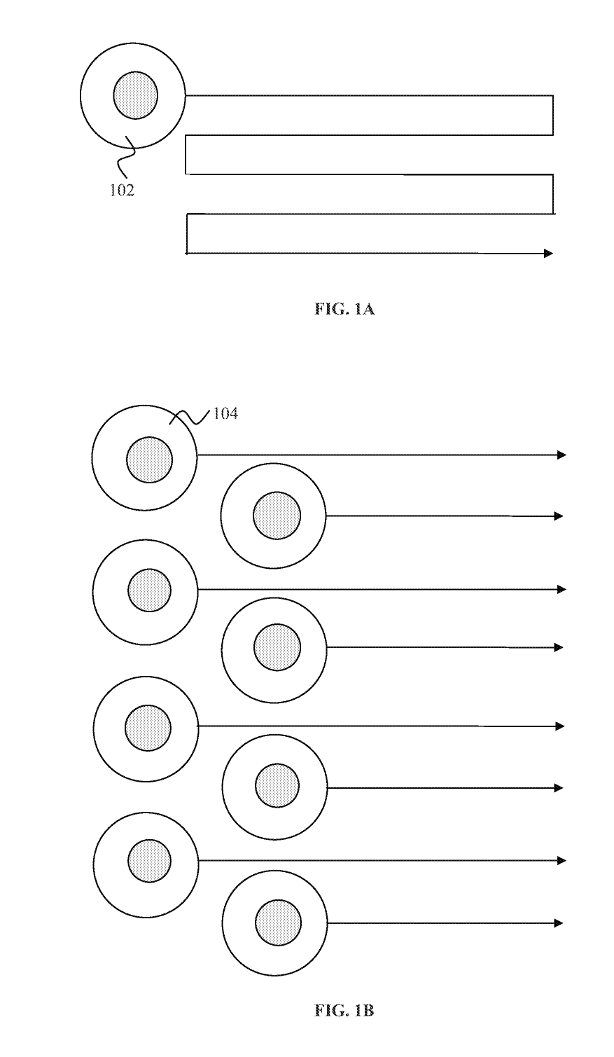

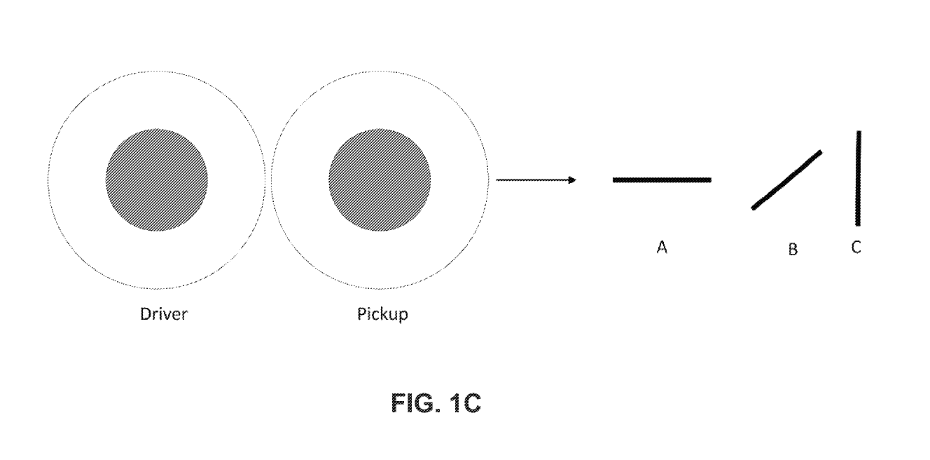

FIG. 1A is a schematic depiction of an illustrative eddy current scan.

FIG. 1B is a schematic depiction of an illustrative eddy current scan.

FIG. 1C is a schematic depiction of an illustrative eddy current driver-pickup coil arrangement.

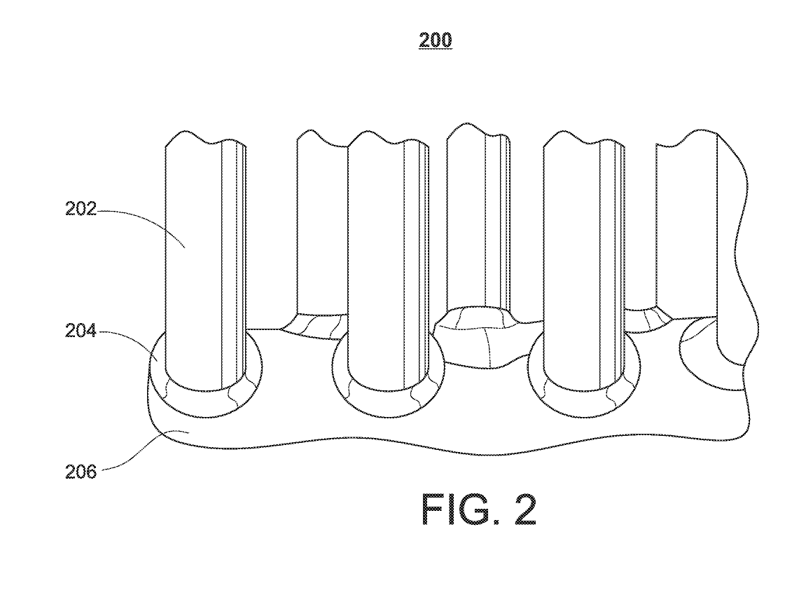

FIG. 2 is a partial elevation view of an illustrative header, tubes and tube-to-header welds of a heat recovery steam generator.

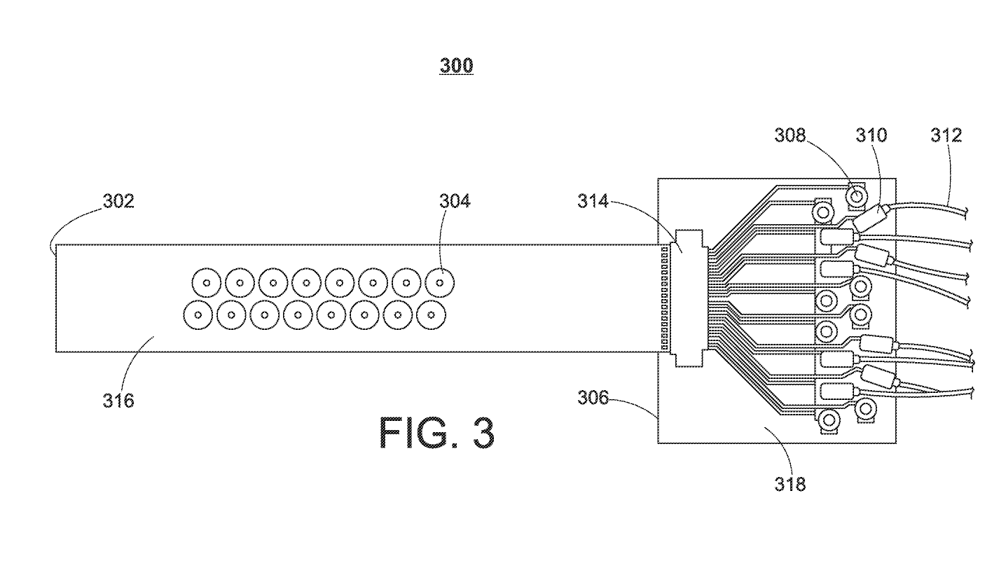

FIG. 3 is a schematic depiction of an illustrative flexible eddy current probe.

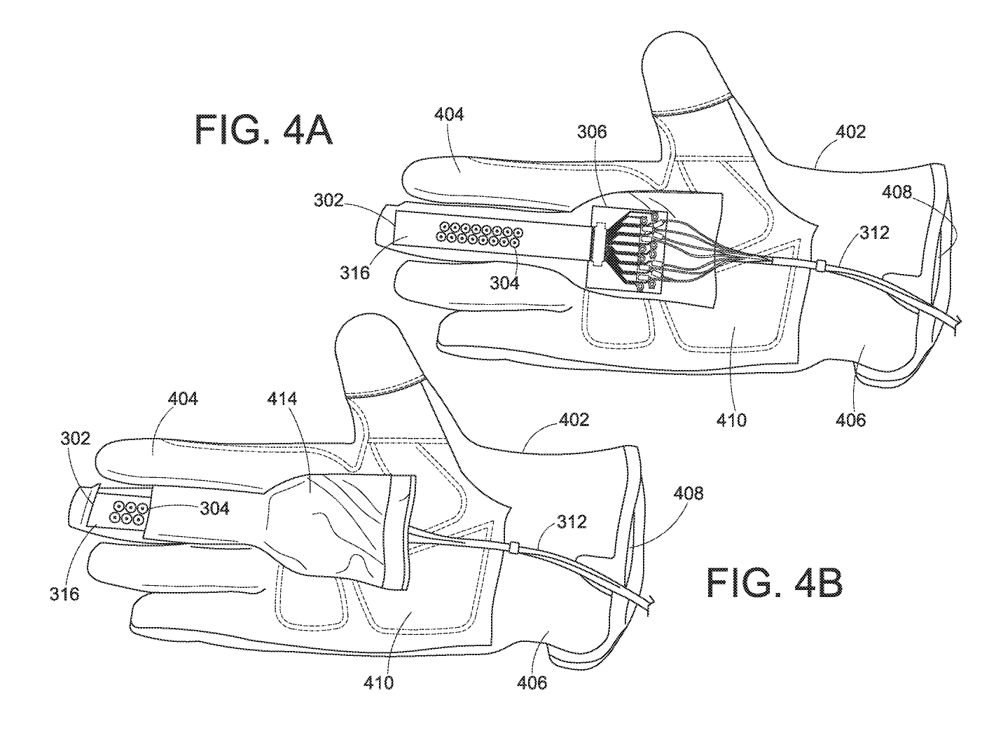

FIG. 4A is a schematic depiction of an illustrative flexible eddy current probe associated with an operator's glove.

FIG. 4B is a schematic depiction of an illustrative flexible eddy current probe associated with an operator's glove.

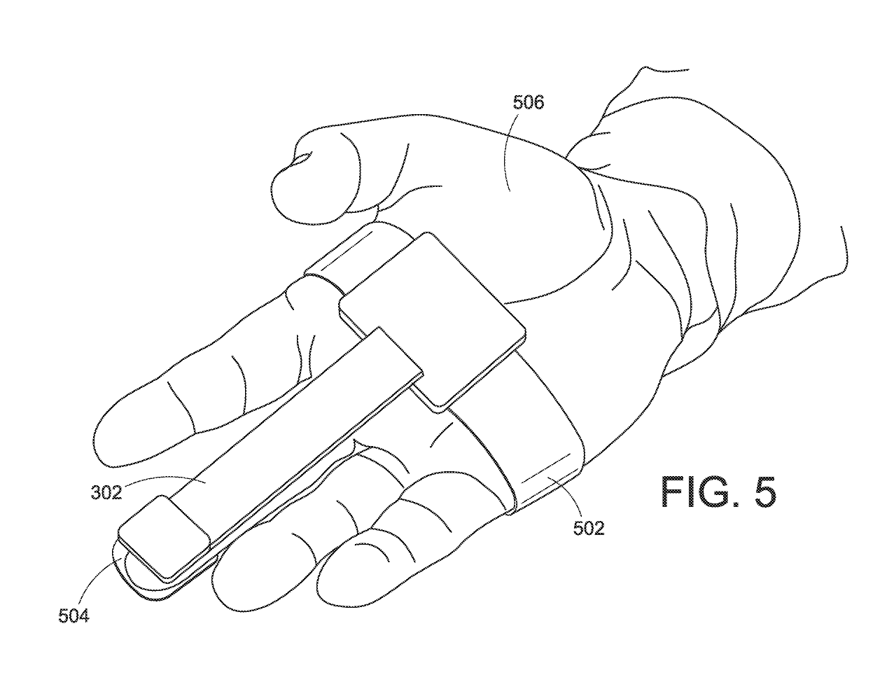

FIG. 5 is a schematic depiction of an illustrative flexible eddy current probe associated with an operator's hand.

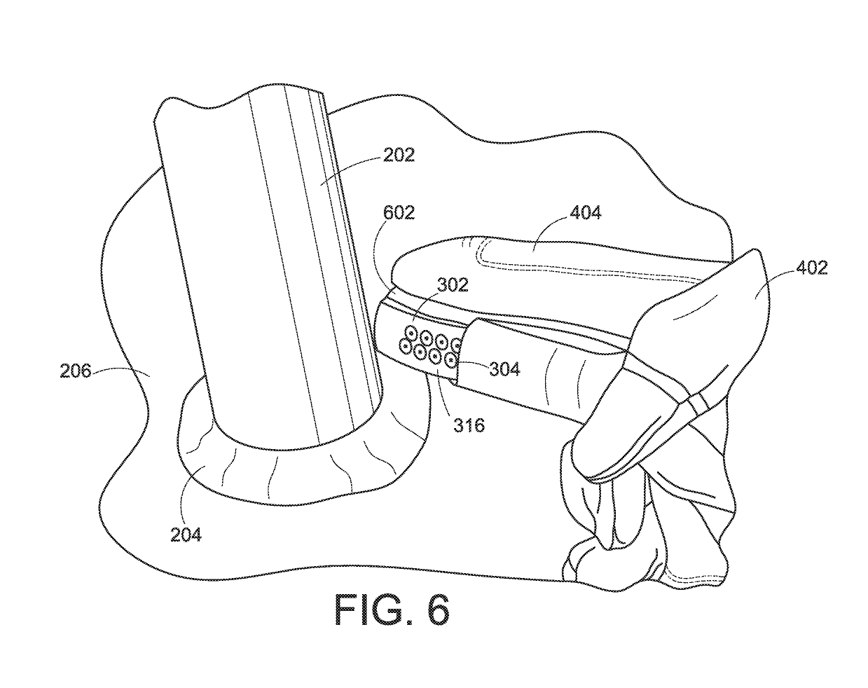

FIG. 6 is a schematic depiction of an illustrative flexible eddy current probe in proximity to a tube-to-header weld of a heat recovery steam generator.

Provided is a flexible eddy current probe and a method of non-destructive testing. According to certain illustrative embodiments, a flexible eddy current probe comprises (a) at least one substantially planar eddy current array capable of measuring an electromagnetic condition of a portion of a test object, wherein the at least one eddy current array is disposed on a flexible substrate, and wherein the flexible substrate is conformable to a portion of the test object; (b) at least one elongated electrical conductor capable of electrically connecting the at least one eddy current array to a test instrument; and (c) at least one finger or palm strap operable to removably attach the at least one flexible eddy current array to an operator's hand.

In other embodiments, a flexible eddy current probe comprises (a) at least one substantially planar eddy current array capable of measuring an electromagnetic condition of a portion of a test object, wherein the at least one eddy current array is disposed on a flexible substrate, and wherein the flexible substrate is conformable to a portion of the test object, (b) at least one elongated electrical conductor capable of electrically connecting the at least one eddy current array to a test instrument, and (c) a glove capable of being fitted to an operator's hand, wherein the glove is capable of carrying the at least one flexible eddy current array and conforming the array in testing communication with the test object.

In accordance with further illustrative embodiments, a method of non-destructive testing comprises (a) providing a flexible eddy current probe having (i) at least one substantially planar eddy current array capable of measuring an electromagnetic condition of a portion of a test object, wherein the at least one eddy current array is disposed on a flexible substrate, and wherein the flexible substrate is conformable to a portion of the test object, (ii) at least one elongated electrical conductor capable of electrically connecting the eddy current array to a test instrument; and (iii) a glove capable of carrying the at least one flexible eddy current array, (b) placing an operator's hand in the glove, (c) positioning the operator's gloved hand such that the flexible eddy current probe is in operative contact with the test object, (d) performing a test by applying manual pressure to the flexible eddy current probe so as to conform the eddy current array to a portion of the surface of the test object and inducing an eddy current in the test object, (e) measuring an electromagnetic condition of a portion of the test object utilizing the test instrument by receiving at least one return signal and (f) evaluating the at least one return signal measured to identify one or more defects in the test object.

Eddy current testing is a non-destructive testing technique based on electromagnetic induction. In an eddy current probe, an alternating current flows through a coil of electrically conductive material and generates an oscillating magnetic field. When the probe and its magnetic field are brought close to a conductive material, such as a metal test object, a circular flow of electrons, known as an eddy current, will begin to move through the metal. The eddy current flowing through the metal generates its own magnetic field, which will interact with the coil and its field through mutual inductance. Changes in metal thickness or defects such as cracking, or corrosion, will alter the amplitude and pattern of the eddy current and the resulting magnetic field. This interruption, or alteration, in turn affects the movement of electrons in the coil by varying the electrical impedance of the coil.

These changes may be sensed by their effect on the electrical impedance of the coil. This approach is known as an absolute coil arrangement. Other embodiments for sensing the changes includes the use of two coils. A first coil (driver) may induce eddy currents into the conductive material, and a second sensing coil (pickup) may detect the eddy currents by a voltage induced into the sensing coil. This approach is known as a driver-pickup arrangement. In an embodiment, multiple sensing coils may be used with a single driving coil. Multiple sensing coils may be placed at different clock positions around a driving coil to increase the sensing area. The driver-pickup arrangement may have advantages such as, for example, reduced sensitivity to probe lift-off variations and to noise caused by, for example, the flexing of a flexible coil.

Sensors used to perform eddy current tests, or inspections, may be comprised of, for example, a copper wire wound to form a coil. In an embodiment, an exemplary eddy current sensor, or coil, may comprise a metal trace disposed on a flexible printed circuit board. The coil shape is generally circular but may vary to better suit specific applications. An alternating current may be generated by a test instrument and caused to flow through the coil at a chosen frequency thereby generating a magnetic field around the coil. When the coil is placed in proximity to an electrically conductive material, an eddy current is induced in the material. Flaws in the conductive material, or test object, may disturb the eddy current circulation. Perturbations of the eddy current circulation may change the magnetic coupling between the probe and the test object and a return signal may be read by measuring a feature, for example the coil impedance variation, via the test instrument and correlating the variation to a feature or flaw in the test object. In a driver pickup arrangement, the eddy current is induced by a driver coil, and the return signal is sensed by a pickup coil.

In other embodiments, a flexible eddy current probe may be configured for detection of circumferential flaws in a tube-to-header weld. Alternatively, the flexible eddy current probe may be configured for detection of flaws in other orientations. In a further embodiment, multiple eddy current arrays, which may be displaced axially, may be utilized for coverage of the test object, or inspection area.

An absolute coil arrangement is sensitive to flaws in any orientation. However, flexing of the coil or lift-off variations may result in large undesirable background signal deviations that may obscure the flaw signals. The driver-pickup coil arrangement may help reduce probe sensitivity to flexing, and/or lift-off variations, but may be sensitive to flaw orientation. For instance, a flaw may be detected when both the driver and pickup coils are simultaneously located over, or in close proximity to, a portion of the flaw.

For detection of circumferentially-oriented flaws in a tube-to-header weld, the driver and pickup coils may be arranged so that a line connecting the centers of the coils is substantially in the circumferential direction. Likewise, for detection of axially-oriented flaws, a line connecting the centers of both coils may be substantially in the axial direction. FIG. 1C illustrates the orientation of crack-like flaws that may be sensed by a driver-pickup arrangement. The illustrated driver-pickup arrangement may detect flaws in the orientation of lines A and B, while flaws in the orientation of line C may not be detected.

Measurements of sections of a test object can be made by directing an eddy current probe along the surface of a test object and monitoring the differences between a drive signal and a return signal generated by the eddy current electromagnetic field. However, structures having surfaces with complex geometries are difficult to inspect since conventional eddy current probes are comprised of rigid wire-wound coils that must remain in close proximity to the surface of the test object with the probe axis nominally perpendicular to the surface. The complex curvature of the weld may cause varying degrees of lift-off and tilt between the probe and the weld surface.

Eddy current measurements are very sensitive to the variations of the sensor positioning relative to the test object. The flaw detection sensitivity of an eddy current probe is decreased by a “lift-off” effect when the gap between the probe and the surface being inspected increases. Therefore, when conducting an eddy current test, the lift-off effect may be diminished by maintaining a close, tight fit between the surface of the test object and the eddy current probe coils. Maintaining a close, tight fit is challenging when the test object is in a hard to access area and/or has an irregular surface. Similarly, the angle of orientation, or tilt, of the probe may cause noise signals that can obscure the signals indicative of a flaw. In an embodiment, the flexible eddy current probe of the present disclosure may be easily conformed to the test object,thereby overcoming the lift-off and tilt problems associated with conventional eddy current probes.

In accordance with an embodiment, the flexible eddy current probe may comprise an eddy current array. Eddy current array testing and conventional eddy current technology share the same basic principles. Alternating current injected into a coil creates a magnetic field in a conductive part, or test object, when the coil is placed near the test object. Defects in the test object disturb the path of the eddy currents and the disturbance may be measured by the coil through a return signal. In an embodiment, the coils may comprise a driver-pickup arrangement wherein a driver coil is excited with an alternating current to generate an eddy current in the test object and a pick-up coil may detect changes in the induced eddy current caused by defects in the test object. In other embodiments, a coil may function as both a driver and a pick-up coil.

Eddy current array testing is a technology that provides the ability to simultaneously drive and read multiple eddy current coils placed side by side in the same sensor or probe assembly. Data acquisition may be performed by multiplexing the eddy current sensors, or coils, in a desired pattern. Each individual coil, or sensor, may produce a signal, for example, representative of the structure below it. Data from the return signal may be referenced to an encoded position and time and may be represented by the test instrument graphically as an image.

Eddy current array testing provides advantages over conventional eddy current testing. Eddy current array testing may significantly reduce inspection time and provide the ability to cover large inspection areas in a single pass. Conventional eddy current testing, as demonstrated in FIG. 1A, generally utilizes a single coil 102 which performs a relatively slow raster scan. A conventional eddy current test probe utilizing a single coil inspects only the surface directly beneath, therefore, the test object must be scanned by moving the probe over the test area in an overlapping pattern. This effort is time consuming and tedious. By contrast, and as shown in FIG. 1B, eddy current array technology may utilize multiple coils 104 and a much faster one-line scan that may allow for test coverage of larger areas in a single probe pass while maintaining high resolution.

FIG. 2 is a partial elevation view of an illustrative tube-to-header structure 200 such as in a heat recovery steam generator of an electric power plant. The tube-to-header weld joint 204 is created when the tube 202 is welded to the header portion 206. Because the weld connections 204 encounter loads and fatigue during their service lifetime, there is a chance that they may fail. The weld joints must be inspected periodically, but have complex, irregular shapes and thus are difficult to access with conventional eddy current probes.

As shown in FIG. 3, an illustrative flexible eddy current probe 300 may comprise a flexible eddy current array 302 comprising a flexible printed circuit board 316 and at least one coil 304. The coil 304 is capable of receiving an alternating current from a test instrument, inducing an eddy current in a test object and sensing a return signal indicative of an electromagnetic feature of the test object. In an embodiment, the flexible eddy current array 302 may comprise coils 304 constructed on a thin, flexible plastic substrate 316. Traditional eddy current coils utilize wire wound around a core. By contrast, the coils 304 of the flexible eddy current array 302 of the present disclosure may utilize thin metal lines, or traces, deposited on a flexible plastic-like material, such as a flexible printed circuit board 316.

The rigid connector part 306 may comprise, for example, a printed circuit board 318 including a plurality of connectors 308 for engaging the connectors 310 of the insulated electrical conductors 312. In an embodiment, the rigid connector part 306 is capable of providing an electrical connection between the eddy current array 302 and the at least one elongated electrical conductor 312. The rigid connector part 306 and insulated electrical conductors 312 may provide a physical and electrical transition from the flexible eddy current sensor to a test instrument.

The flexible eddy current probe may comprise at least one elongated electrical conductor capable of electrically connecting the eddy current array 302 to a test instrument. The electrical conductors 312 may comprise individual wires or a cable and may be connected to a rigid connector part 306 which is engaged with and electrically connected to the eddy current array 302.

In some embodiments, the electrical conductors 312 are in communication with a test instrument capable of sending, receiving, interpreting and displaying signals representative of eddy current testing. A commercially available test instrument may provide the ability to electronically drive and read several eddy current sensors positioned side by side in the same probe assembly. In certain embodiments, multiplexing of signals from multiple probes may be used to reduce the number of electronic channels, to utilize multiple frequencies to excite each probe, or to change probe functions, for example, to change a coil's operation from driver to pickup.

Still referring to FIG. 3, the flexible printed circuit board 316 may be removeably engaged with a rigid connector part 306, for example, via connector 314. Over time, any of the flexible printed circuit board 316, the rigid connector part 318 or the electrical conductors 312 may become worn or defective. Connector 314 allows either the flexible printed circuit board 316 or the connector part 306 to be easily removed and replaced, thereby minimizing downtime. Similarly, a worn, damaged or faulty electrical conductor 312 may be replaced utilizing the appropriate connectors, for example, connectors 308, 310.

Referring now to FIG. 4A, the flexible eddy current probe may be removably engaged with, for example, a glove 402. The glove may comprise a fingers section 404, and a base section 406 having an opening 408, the fingers section 404 connected to the base section 406 opposite the opening. The base section 406 includes a palm portion 410. In accordance with an embodiment, the flexible printed circuit board 316 portion of the probe may be secured to at least one of the fingers section 404, the base section 406, or the palm portion 410 of the glove 402, and/or combinations thereof. In some embodiments, the glove may comprise a heat-resistant material, for example, silicone, leather, Kevlar® cloth, machine knit carbon and/or wool. In further embodiments, the glove may comprise neoprene, cloth, nylon, rubber, plastic, canvas, and/or spandex.

In certain embodiments, the glove 402 may be capable of providing abrasion, cut, chemical and/or heat resistance in order to protect the inspector's hand from the test object or the surrounding area. The protection provided by the glove may allow the operator to perform accurate, efficient eddy current testing of objects that may otherwise be uncomfortable, inaccessible, or unsafe to contact. The glove-mounted flexible eddy current probe may enable a method of eddy current testing that is more comfortable for the operator and may aid in reducing fatigue and repetitive stress injuries of the hand when compared to the use of conventional eddy current probes.

As shown in FIG. 4B, the flexible eddy current probe 300, comprising the flexible eddy current array 302, rigid connector part 306 and/or the electrical conductors 312, may be removably engaged with a glove by, for example, being held within a pocket 414. The pocket 414 may be sewn, or otherwise suitably fastened, to the glove. In other embodiments, any of the flexible eddy current array, rigid connector part and/or electrical conductors may be removably carried by the glove utilizing a fastener, for example, a hook and loop fastener such as a Velcro® fastener.

FIG. 5 is a schematic depiction of an illustrative flexible eddy current probe. The flexible eddy current array 302 may be removably secured to an operator's hand 506 utilizing at least one palm or finger strap 502, 504 to attach the probe to a palm and/or fingers portion of the operator's hand 506. The finger or palm strap may comprise, for example, cloth, leather, elastic, Velcro® fastener or other material suitable for removably securing the flexible eddy current array 302 to an operator's hand 506.

Turning now to FIG. 6, tube-to-header weld inspection, or testing, may be simplified using the glove-mounted flexible eddy current sensor probe, in that the inspector may easily reach between the tubes to access the weld joints. Adequate contact of the probe to the weld joint is readily maintained and controlled, as the flexible probe is coupled with the operator's hand, and the operator may apply a suitable amount of manual pressure to provide sufficient contact between the probe and the weld joint, thereby minimizing problems associated with the lift-off effect. The operator may scan the test object, for example, by scanning, or moving, the flexible eddy current probe 300 mounted on the glove 402 worn by the operator along or over a surface of the test object.

In some embodiments, a pliable material 602, such as foam rubber, may be installed between the eddy current array 302 and the operators hand to provide proximity between the eddy current array 302 and the test object 202. The pliable material 602 may aid in conforming the sensor to the test material, particularly when the surface of the test object is irregular. The pliable material 602 may aid in applying an even pressure to the surface of the material to be tested, for example, a weld joint. In some embodiments the pliable material may comprise for example, suitable padding, a gel-filled cushion or other pliable material capable of providing proximity to and/or a bias between the eddy current array and to the test object.

Still referring to FIG. 6, a method of non-destructive testing may comprise providing a flexible eddy current probe 300 having at least one substantially planar eddy current array 302 capable of measuring an electromagnetic condition of a portion of a test object 202, wherein the at least one eddy current array 304 is disposed on a flexible substrate 316, and wherein the flexible substrate 316 is conformable to a portion of the test object 202, at least one elongated electrical conductor (not shown) capable of electrically connecting the eddy current array to a test instrument; and a glove 402 capable of carrying the at least one flexible eddy current array 302. The glove 402 may be fitted to an operator's hand, and the operator's gloved hand may be positioned such that the flexible eddy current probe 300 is in contact with the test object 202. An eddy current test may be performed by a) applying manual pressure to the flexible eddy current probe 300 so as to conform the eddy current array 302 to a portion of the surface of the test object 202 and b) inducing an eddy current in the test object 202.

An electromagnetic condition of a portion of the test object 202 may be measured utilizing, for example, the test instrument by receiving at least one return signal. An electromagnetic condition of a portion of the test object may be measured, for example, by monitoring an electrical characteristic of the eddy current array such as impedance or voltage. The at least one return signal measured may be evaluated to identify one or more features or defects in the test object 202.

In accordance with an embodiment, a suitable test instrument may comprise an eddy current flaw detector such as, for example, the commercially available Olympus OmniScan™ MX EC. The commercially available test instrument hardware, and associated software, may be capable of generating and receiving multiplexed signals useful for eddy current array testing. The test instrument may include eddy current array test data acquisition, processing, synchronization, storage and display capabilities.

A first embodiment provides a flexible eddy current probe comprising (a) at least one substantially planar eddy current array capable of measuring an electromagnetic condition of a portion of a test object, wherein the at least one eddy current array is disposed on a flexible substrate, and wherein the flexible substrate is conformable to a portion of the test object, (b) at least one elongated electrical conductor capable of electrically connecting the at least one eddy current array to a test instrument, and (c) at least one finger or palm strap operable to removably attach the at least one flexible eddy current array to an operator's hand.

A second embodiment provides a flexible eddy current probe comprising (a) at least one substantially planar eddy current array capable of measuring an electromagnetic condition of a portion of a test object, wherein the at least one eddy current array is disposed on a flexible substrate, and wherein the flexible substrate is conformable to a portion of the test object, (b) at least one elongated electrical conductor capable of electrically connecting the at least one eddy current array to a test instrument, and (c) a glove capable of being fitted to an operator's hand, wherein the glove is capable of carrying the at least one flexible eddy current array and conforming the array in testing communication with the test object.

The flexible eddy current probe of the second embodiment may further include that the glove comprises at least one fingers section, and a base section having an opening, the fingers section connected to the base section opposite the opening, wherein the base section includes a palm portion.

The flexible eddy current probe of the second or subsequent embodiments may further include that the glove is capable of carrying the at least one eddy current array at the fingers section, the base section and/or the palm portion of the glove.

The flexible eddy current probe of the second or subsequent embodiments may further include that the glove is capable of carrying the at least one eddy current array utilizing a pocket, a strap, and/or a fastener.

The flexible eddy current probe of the second or subsequent embodiments may further include that the glove comprises a heat-resistant material.

The flexible eddy current probe of the second or subsequent embodiments may further include that the glove comprises silicone, neoprene, leather, cloth, nylon, rubber, plastic, canvas, or spandex.

The flexible eddy current probe of the first, second or any of the subsequent embodiments may further include that the at least one flexible eddy current array comprises a plurality of eddy current sensors capable of multiplexed operation.

The flexible eddy current probe of the first, second or any of the subsequent embodiments may further include that the flexible substrate is a flexible printed circuit board.

The flexible eddy current probe of the first, second or any of the subsequent embodiments may further include that the plurality of eddy current sensors comprises a two dimensional array of transducers printed on the flexible circuit board.

The flexible eddy current probe of the first, second or any of the subsequent embodiments may further include a resilient material disposed between the at least one flexible eddy current array and the operator's hand, wherein the resilient material is operative to provide proximity between the eddy current array and the test object.

The flexible eddy current probe of the first, second or any of the subsequent embodiments may further include a rigid connector part interposed between the at least one eddy current array and the at least one elongated electrical conductor.

The flexible eddy current probe of the first, second or any of the subsequent embodiments may further include that the rigid connector part comprises a printed circuit board capable of providing an electrical connection between the at least one eddy current array and the at least one elongated electrical conductor.

The flexible eddy current probe of the first, second or any of the subsequent embodiments may further include that the printed circuit board is removably connected to the at least one eddy current array and the at least one elongated electrical conductor

In a third embodiment, a method of non-destructive testing comprises (a) providing a flexible eddy current probe having (i) at least one substantially planar eddy current array capable of measuring an electromagnetic condition of a portion of a test object, wherein the at least one eddy current array is disposed on a flexible substrate, and wherein the flexible substrate is conformable to a portion of the test object, (ii) at least one elongated electrical conductor capable of electrically connecting the eddy current array to a test instrument, and (iii) a glove capable of carrying the at least one flexible eddy current array, (b) placing operator's hand in the glove, (c) positioning the operator's gloved hand such that the flexible eddy current probe is in operative contact with the test object, (d) performing a test by applying manual pressure to the flexible eddy current probe so as to conform the eddy current array to a portion of the surface of the test object and inducing an eddy current in the test object, (e) measuring an electromagnetic condition of a portion of the test object utilizing the test instrument by receiving at least one return signal, and (f) evaluating the at least one return signal to identify one or more defects in the test object.

The method of the third embodiment may further include that inducing an eddy current in the test object includes sending an alternating current capable of inducing an eddy current in the test object from the test instrument to the eddy current array.

The method of the third or any of the subsequent embodiments may further include that performing a test by applying manual pressure to the flexible eddy current probe comprises scanning the eddy current probe over a surface of the test object.

The method of the third or any of the subsequent embodiments may further include that measuring an electromagnetic condition of a portion of the test object includes monitoring an electrical characteristic of the eddy current array.

The method of the third or any of the subsequent embodiments may further include that the test object is a weld.

The method of the third or any of the subsequent embodiments may further include that the weld is a tube-to-header weld of a heat recovery steam generator.

The embodiments described above are not necessarily in the alternative, as various embodiments may be combined to provide the desired results.

1. A flexible eddy current probe comprising:
at least one substantially planar eddy current array capable of measuring an electromagnetic condition of a portion of a test object, wherein the at least one eddy current array is disposed on a flexible substrate, and wherein the flexible substrate is conformable to a portion of the test object;
at least one elongated electrical conductor capable of electrically connecting the at least one eddy current array to a test instrument; and
at least one finger or palm strap operable to removably attach the at least one flexible eddy current array to an operator's hand.

2. A flexible eddy current probe comprising:
at least one substantially planar eddy current array capable of measuring an electromagnetic condition of a portion of a test object, wherein the at least one eddy current array is disposed on a flexible substrate, and wherein the flexible substrate is conformable to a portion of the test object;
at least one elongated electrical conductor capable of electrically connecting the at least one eddy current array to a test instrument; and
a glove capable of being fitted to an operator's hand, wherein the glove is capable of carrying the at least one flexible eddy current array and conforming the array in testing communication with the test object.

3. The flexible eddy current probe of claim 2, wherein the glove comprises at least one fingers section, and a base section having an opening, the fingers section connected to the base section opposite the opening, wherein the base section includes a palm portion.

4. The flexible eddy current probe of claim 2, wherein the glove is capable of carrying the at least one eddy current array at the fingers section, the base section and/or the palm portion of the glove.

5. The flexible eddy current probe of claim 4, wherein the glove is capable of carrying the at least one eddy current array utilizing a pocket, a strap, and/or a fastener.

6. The flexible eddy current probe of claim 2, wherein the glove comprises a heat-resistant material.

7. The flexible eddy current probe of claim 2, wherein the glove comprises silicone, neoprene, leather, cloth, nylon, rubber, plastic, canvas, or spandex.

8. The flexible eddy current probe of claim 1, wherein the at least one flexible eddy current array comprises a plurality of eddy current sensors capable of multiplexed operation.

9. The flexible eddy current probe of claim 1, wherein the flexible substrate is a flexible printed circuit board.

10. The flexible eddy current probe of claim 1, wherein the plurality of eddy current sensors comprises a two dimensional array of transducers printed on the flexible circuit board.

11. The flexible eddy current probe of claim 1, including a resilient material disposed between the at least one flexible eddy current array and the operator's hand, wherein the resilient material is operative to provide proximity between the eddy current array and the test object.

12. The flexible eddy current probe of claim 1, including a rigid connector part interposed between the at least one eddy current array and the at least one elongated electrical conductor.

13. The flexible eddy current probe of claim 12, wherein the rigid connector part comprises a printed circuit board capable of providing an electrical connection between the at least one eddy current array and the at least one elongated electrical conductor.

14. The flexible eddy current probe of claim 13, wherein the printed circuit board is removably connected to the at least one eddy current array and the at least one elongated electrical conductor.

15. A method of non-destructive testing, the method comprising:
providing a flexible eddy current probe having
at least one substantially planar eddy current array capable of measuring an electromagnetic condition of a portion of a test object, wherein the at least one eddy current array is disposed on a flexible substrate, and wherein the flexible substrate is conformable to a portion of the test object,
at least one elongated electrical conductor capable of electrically connecting the eddy current array to a test instrument; and
a glove capable of carrying the at least one flexible eddy current array;
placing an operator's hand in the glove;
positioning the operator's gloved hand such that the flexible eddy current probe is in operative contact with the test object;
performing a test by applying manual pressure to the flexible eddy current probe so as to conform the eddy current array to a portion of the surface of the test object and inducing an eddy current in the test object;
measuring an electromagnetic condition of a portion of the test object utilizing the test instrument by receiving at least one return signal;
evaluating the at least one return signal to identify one or more defects in the test object.

16. The method of claim 15, wherein performing a test by applying manual pressure to the flexible eddy current probe comprises scanning the eddy current probe over a surface of the test object.

17. The method of claim 15, wherein inducing an eddy current in the test object includes sending an alternating current capable of inducing an eddy current in the test object from the test instrument to the eddy current array.

18. The method of claim 15, wherein measuring an electromagnetic condition of a portion of the test object includes monitoring an electrical characteristic of the eddy current array.

19. The method of claim 15, wherein the test object is a weld.

20. The method of claim 19, wherein the weld is a tube-to-header weld of a heat recovery steam generator.

21. The flexible eddy current probe of claim 2, wherein the at least one flexible eddy current array comprises a plurality of eddy current sensors capable of multiplexed operation.

22. The flexible eddy current probe of claim 2, wherein the flexible substrate is a flexible printed circuit board.

23. The flexible eddy current probe of claim 2, wherein the plurality of eddy current sensors comprises a two dimensional array of transducers printed on the flexible circuit board.

24. The flexible eddy current probe of claim 2, including a resilient material disposed between the at least one flexible eddy current array and the operator's hand, wherein the resilient material is operative to provide proximity between the eddy current array and the test object.

25. The flexible eddy current probe of claim 2, including a rigid connector part interposed between the at least one eddy current array and the at least one elongated electrical conductor.

26. The flexible eddy current probe of claim 25, wherein the rigid connector part comprises a printed circuit board capable of providing an electrical connection between the at least one eddy current array and the at least one elongated electrical conductor.

27. The flexible eddy current probe of claim 26, wherein the printed circuit board is removably connected to the at least one eddy current array and the at least one elongated electrical conductor.

28. The method of claim 16, wherein the test object is a weld.

29. The method of claim 17, wherein the test object is a weld.

30. The method of claim 18, wherein the test object is a weld.
